(19) United States
(12) Patent Application Publication
(10) Pub. No.: US 2004/0148282 A1
(43) Pub. Date: Jul. 29, 2004

(54) Database searching device and method

(76) Inventor: James L. Gardiner, Oregon City, OR (US)

Correspondence Address: KUNZLER & ASSOCIATES, 8 EAST BROADWAY, SALT LAKE CITY, UT, 84111, US

(21) Appl. No.: 10/759,625

(22) Filed: Jan. 15, 2004

Related U.S. Application Data
(60) Provisional application No. 60/440,809, filed on Jan. 17, 2003.

(51) Int. Cl. G06F 7/00

(52) U.S. Cl. 707/3

(57) ABSTRACT

A device and method for searching databases of cemetery records use a graphical user interface to display to a user a representation of the records arranged to reflect the relative location of graves to which the biographical information contained in the records pertains. The graphical user interface may display an alphabetical list of names of deceased individuals contained within the records as well as digital photos and digital video of headstones. Records may be accessed according to cemetery, in alphabetical order. Records may also be accessed by viewing a representation such as an image of a gravestone, and other records may be accessed according to the location of the graves.

### RELATED APPLICATIONS

This application is a Continuation of and claims priority to U.S. Provisional Patent Application Serial No. 60/440,809 filed on Jan. 17, 2003.

### BACKGROUND OF THE INVENTION

1. Field of the Invention

This invention relates to devices and methods for improving genealogy searches, and more particularly, relates to devices and methods for searching a database of cemetery records.

2. Description of the Related Art

Genealogy is often explained as family history research, or by the more popular expression: tracing your roots. Ancient and modem societies have kept track of lines of ancestors either by memorizing them or by writing them down in order to pass them on to future generations.

Genealogy has become a leisure activity practiced by hundreds of thousands of people in practically every part of the world. Due to technological advances, such as the Internet, genealogical information available to the public has increased dramatically. Some websites on the Internet provide historical information while others may have records such as census, birth, marriage, and death records.

Often, people become discouraged when searching for information pertaining to their ancestors on the Internet because of incomplete records. There may be uncertainty about the location or cemetery where a certain individual is buried, or there may be incomplete information about the deceased individual within the cemetery database. Still, a person may find information regarding one ancestor, but fail to retrieve information regarding other ancestors buried in close proximity, because the person searching for genealogical information was not aware of the ancestors' names and could not perform a detailed search.

Viewing photos of headstones allows a person searching for genealogical information to discover if other names besides the name of the deceased individual are listed on the headstone. Furthermore, viewing photos of surrounding headstones also facilitates the person searching for genealogical information to potentially discover additional ancestors buried near an individual. Often a person does not know the exact name or spelling of a deceased ancestor. By viewing surrounding headstones, the person may discover alternate spellings or names of potential ancestors.

Persons engaged in genealogical research often are unable to physically travel to the actual cemetery. It would be beneficial to provide a device and method that would allow the person to search the database of cemetery records as if the person were physically present at the cemetery. Furthermore, it would be beneficial to allow the person to view images of the cemetery and headstones arranged in the same order as they appear within the cemetery.

What is needed is a device and method that allows a user to search databases of cemetery records. Beneficially, such a device and method would allow a user to view photos of headstones in the same arrangement as they are found within the cemetery.

### SUMMARY OF THE INVENTION

The present invention has been developed in response to the present state of the art, and in particular, in response to the problems and needs in the art that have not yet been fully solved by currently available searching devices. Accordingly, the present invention has been developed to provide a device and method for searching cemetery records that overcome many or all of the above-discussed shortcomings in the art.

The searching device is provided with a logic unit containing a plurality of modules configured to functionally execute the necessary steps of searching cemetery records.

The device, in one embodiment, is configured to provide to a user a database containing records that include biographical information of deceased individuals. The database may include names of cemeteries. Biographical information may include the date of birth, date of death, date of marriage, and the like.

The device is further configured, in one embodiment, to include a graphical user interface (GUI) module configured to display to a user a representation of the records arranged to reflect the relative locations of graves to which the records correspond.

In a further embodiment, the device includes a display module configured to provide an alphabetical list of names of deceased individuals contained within the database of cemetery records to a user.

The device is further configured, in one embodiment, to include a grave image module configured to display digital representations, such as digital photos and digital video, of individual headstones to a user. In one embodiment, the representations of the headstones are arranged in the same order as that of the actual cemetery. The device may also include a password protected website configured to display the digital representations contained within the grave image module to a user.

The device may also include a name module configured to access the records using the name of a deceased individual. The name module facilitates a user to obtain the biographical information of a deceased individual by providing the name of the deceased person. The device further includes a cemetery module configured to access the records using the name of a particular cemetery. The cemetery module facilitates a user to obtain the names of deceased individuals contained within the records of a certain cemetery. The device may also include a location module that facilitates a user to access the records of cemeteries located within a certain geographical location.

In a further embodiment, the website may include a global positioning system (GPS) module configured to provide the geographical coordinates of individual headstones to a user. The GPS module allows a user to obtain the exact physical location of a certain headstone or burial plot.

In a further embodiment, the device may include a sound module that facilitates a phonetic search to be performed on a name. The name may be of a deceased individual, cemetery, or geographical location such as a state, county, district, and the like.

A method of the present invention is also presented for accessing cemetery records. The method in the disclosed embodiments substantially includes the steps necessary to carry out the functions presented above with respect to the operation of the described device. In one embodiment, the method includes providing a database of records that include biographical information of deceased individuals to a user. The method may also include displaying to a user a representation of the records arranged to reflect the relative locations of graves to which the records correspond.

The method, in one embodiment, may also include accessing the representation of the records through a website. In one embodiment, accessing the representations may be conducted using a graphical user interface accessible through a password protected website. In a further embodiment, accessing a GUI module may include providing a computer readable device such as a CD-ROM.

In one embodiment, the method may include displaying an alphabetical list of names of deceased individuals to a user. The alphabetical list facilitates a user to view the names contained in the database records of a cemetery.

The method also may include displaying a digital image of graves to a user. In a further embodiment, the method includes providing the geographical coordinates of a headstone to a user. The geographical coordinates facilitate creating a geographical map of a cemetery through a GUI module. The geographical map allows a user to view the placement and arrangement of headstones in a cemetery.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a device for accessing cemetery records in accordance with the present invention;

FIG. 1a is a block diagram illustrating one embodiment of a name module of the present invention;

FIG. 1b is a graphical illustration of a display containing a GUI display with links to sectors of a graveyard according to one embodiment of the invention;

FIG. 2 is a block diagram illustrating one embodiment of a typical display of the selections of the present invention;

FIG. 2a is a graphical illustration of a GUI display illustrating an arrangement of graves in a sector of a graveyard according to one embodiment of the invention;

FIG. 3 is an enlarged version illustrating one embodiment of a typical display selected from FIG. 2;

FIG. 3a is a graphical illustration of a display containing a GUI display of specific information pertaining to a selected headstone according to one embodiment of the invention;

FIG. 4 is a schematic flow chart diagram illustrating one embodiment of an access method in accordance with the present invention;

FIG. 5 is a schematic flow chart illustrating one embodiment of a login method in accordance with the present invention;

FIG. 5a is a schematic flow chart illustrating one embodiment of a search method in accordance with the present invention;

FIG. 5b is a schematic flow chart illustrating a second embodiment of a search method in accordance with the present invention;

FIG. 6 is a block diagram illustrating one embodiment of a feedback module in accordance with the present invention;

FIG. 7 is a block diagram illustrating one embodiment of an orientation worksheet in accordance with the present invention; and

FIG. 8 is a block diagram illustrating one embodiment of a virtual cemetery map in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

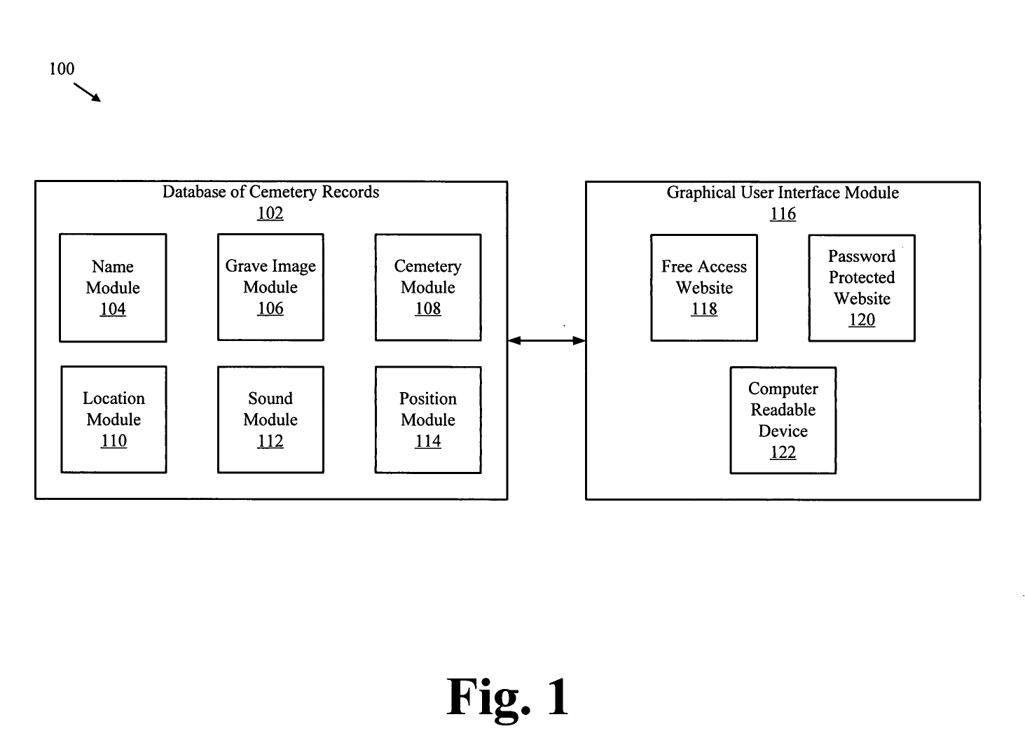

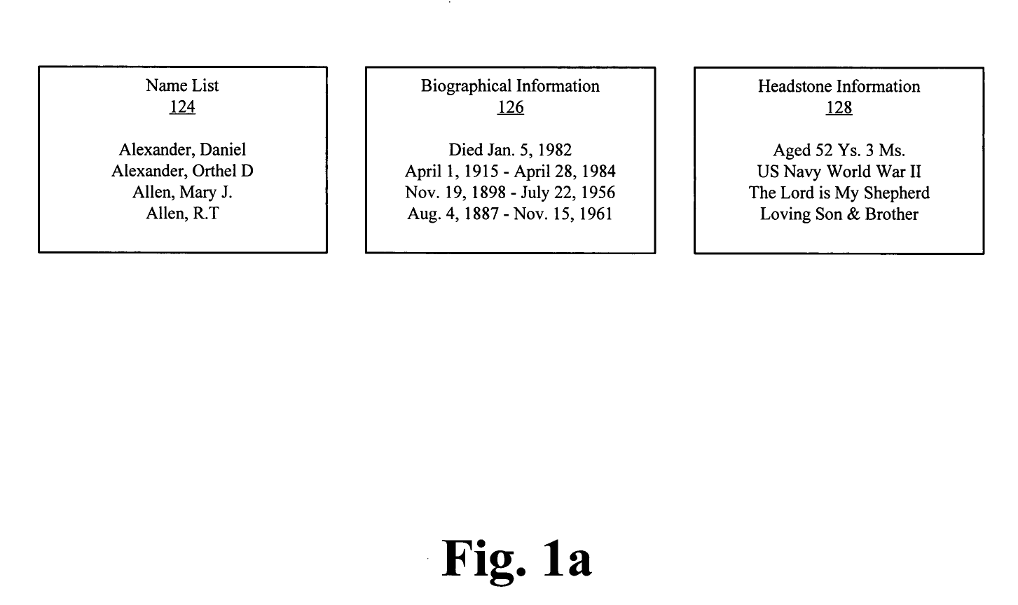

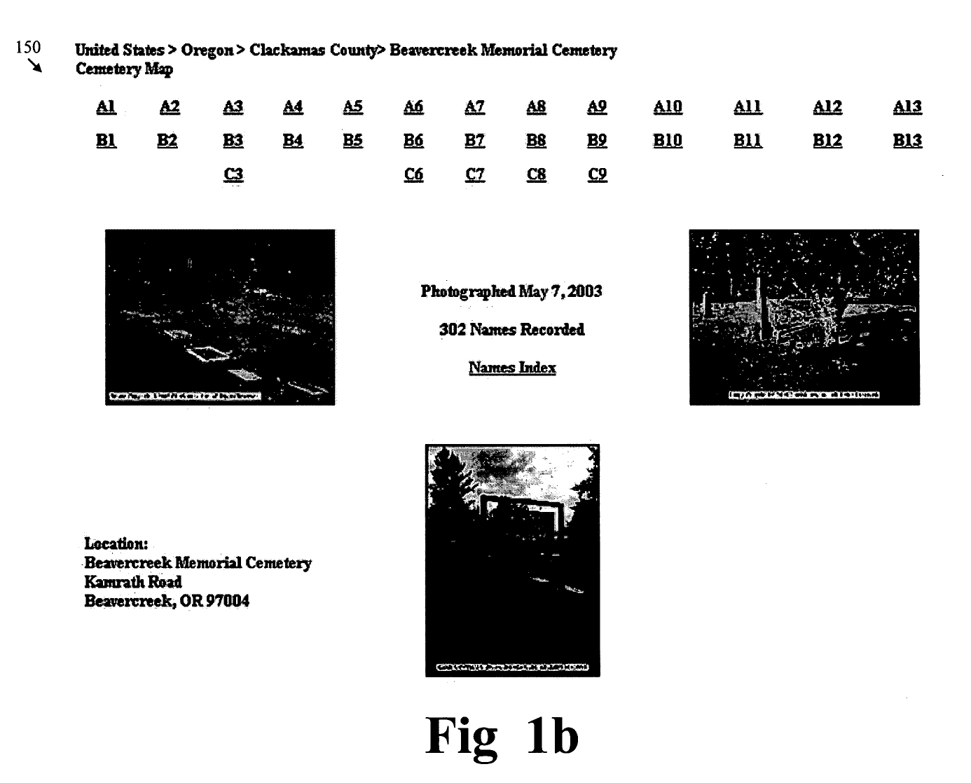

FIG. 1 depicts a device 100 for accessing cemetery records. The device 100 facilitates a user to access a database of records 102 to obtain biographical information regarding deceased individuals located at a cemetery. In one embodiment, the database 102 includes a name module 104. The name module 104 allows a user to access the database 102 by means of submitting a name of a deceased individual. The name module 104 may comprise a computer field within a computer program, website, and the like. A graphical user interface (GUI) module 116 displays the names contained in the database 102 that a user submitted through the name module 104. The GUI module 116 may display the names contained in the database 102 to a user by means of a free access website 118, a password protected website, and a computer readable device 122 such as a CD-ROM.

In a further embodiment, the database 102 further includes a grave image module 106. The grave image module 106 facilitates displaying to a user digital photos and digital videos of graves, headstones, tombstones, and the like to a user by means of the GUI module 116. In one embodiment, the images contained in the grave image module 106 are displayed to a user by means of the password protected website 120.

The database 102 may further include a location module 110 that facilitates a user to access the database 102 of cemeteries located in a certain geographical location. The location module 110 may include a computer field that allows a user to enter a geographical location and access the database 102 of records of cemeteries located in the submitted region.

In a further embodiment, the database 102 may further include a sound module 112 that performs a phonetic search on a name submitted by a user by means of the name module 104. The sound module 112 displays to a user by means of the GUI module 116 alternative spellings of names submitted by a user in the name module 104.

In an alternative embodiment, a user may enter the name of a particular cemetery through a cemetery module 108. The cemetery module 108 facilitates a user to access the database 102 of a certain cemetery and may also comprise a computer field where a user may enter the name of the cemetery. The GUI module 116 may display the names contained in the database 102 of the particular cemetery submitted by a user.

FIG. 1a depicts list of names 124 which may be contained in the database 102 of a particular cemetery and may be displayed alphabetically by means of the free access website 118, the password protected website 120, and the computer readable device 122. The biographical information 126 pertaining to each individual listed in the name list 124 may also be displayed to a user. The biographical information 126 may include the date of birth, death, marriage, and the like. In a further embodiment, the headstone information 128 pertaining to each individual may also be displayed to a user. The headstone information 128 may include messages inscribed on the headstone of the individual.

In one embodiment, a name listed in the name list 124 may include a link to access information such as a website 118 and 120. For example, if a user clicks on the name, “Alexander, Daniel” listed in the name list 124, the GUI module 116 may display to a user a digital photo and digital video through the grave image module 106 of the grave and headstone of “Alexander, Daniel.”

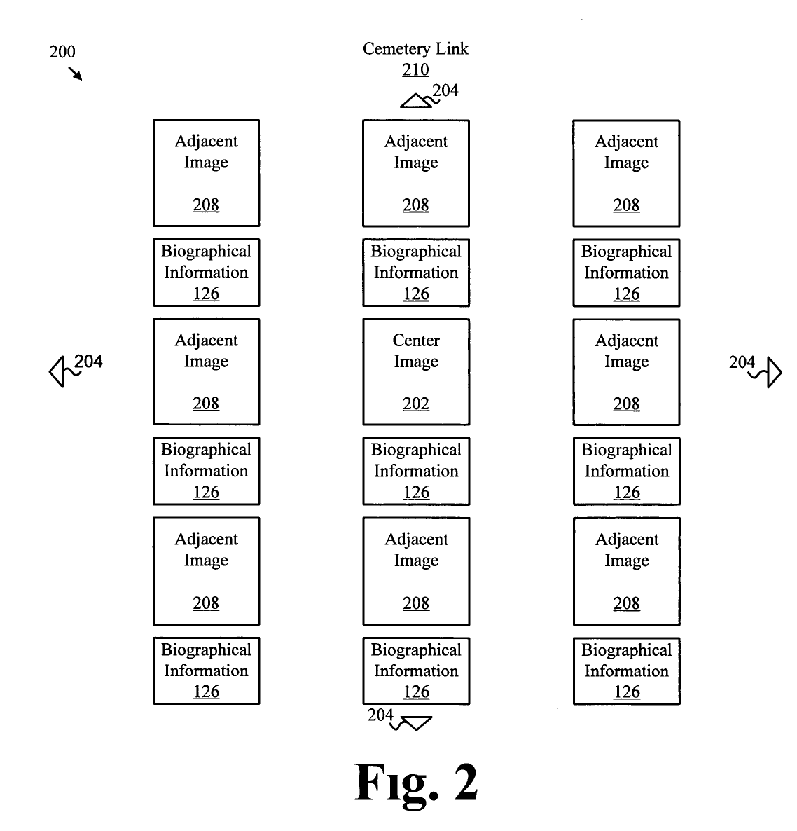

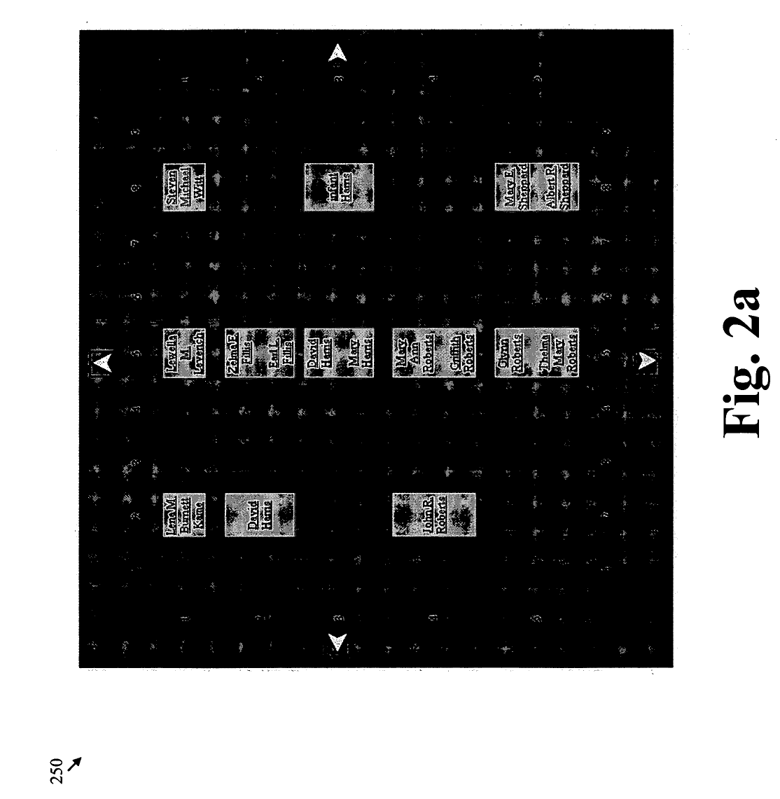

FIG. 1b illustrates one embodiment of a representative example of a graphical display 150 of a logical layout of a graveyard. Links are provided to sectors of a graveyard A user may select a link to view the arrangement of graves in a sector, as shown in FIG. 2a below.

FIG. 2 illustrates a typical headstone display 200 that might be accessed to a user by means of the GUI module 116. In one embodiment, the GUI module 116 provides the display 200 by means of a password protected website 120. The website 120 includes pointers 204 that facilitate a user to scroll up and down, as well as right and left within the website 120. The pointers 204 may be accessed to scroll within the website 120 through use of a computer mouse, keyboard, and the like.

The website 120 may further include a center image 202 located in the center of the website 120. In one embodiment, the center image 202 is accessed from the grave image module 106 and displayed to a user by means of the GUI module 116. The center image 202 may include an image of a headstone, grave, tombstone, and the like. In one embodiment, the center image 202 is the image of the headstone of an individual's name selected from the name list 124 as described in FIG. 1a. For example, if a user selects the name “Alexander, Daniel” from the name list 124, the center image 202 displayed to a user may be an image of the headstone of “Alexander, Daniel.”

In a further embodiment, the biographical information 126 pertaining to the center image 202 may be displayed to a user. The biographical information 126 may include the date of birth, death, marriage, and the like and may be displayed directly below the center image 202.

The website 120 may also include one or more adjacent images 208. In one embodiment, the adjacent images 208 are images of headstones, graves, tombstones, and the like. The adjacent images 208 may be accessed from the grave image module 106 and displayed to a user by means of the GUI module 116. The adjacent images 208 with respect to the center image 202 may be arranged to reflect the location of the graves, headstones, tombstones, and the like as they are arranged in an actual cemetery. Biographical information 126 pertaining to each adjacent image 208 may be placed below each adjacent image 208. This facilitates a user to view the center image 202 and adjacent images 208 in the same arrangement as they are located at a cemetery. This allows a user to possibly discover important biographical information 126 pertaining to other individuals. For example, if a user wishes to obtain biographical information 126 pertaining to the deceased individual of the center image 202, the user may discover relatives of the deceased individual in the center image 202 through biographical information 126 of the adjacent images 208.

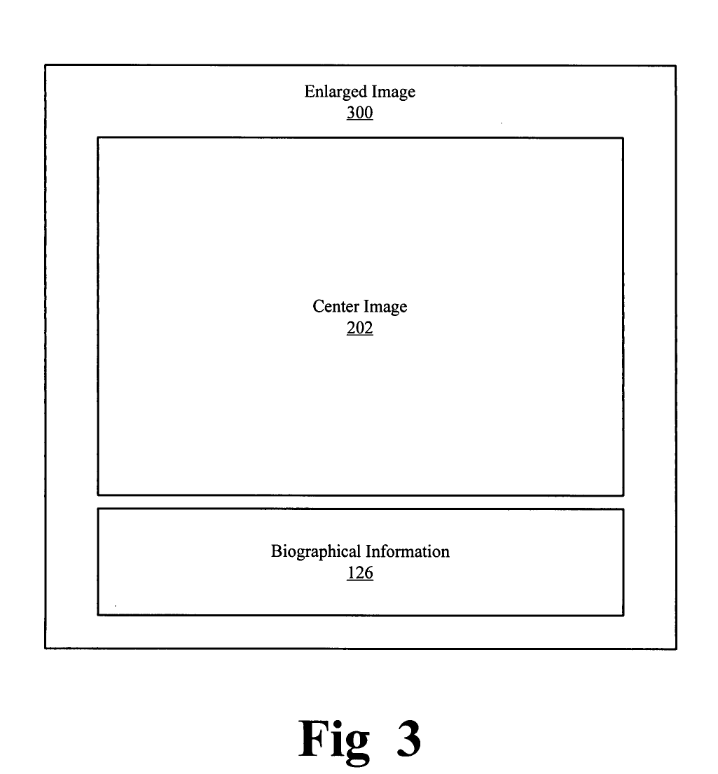

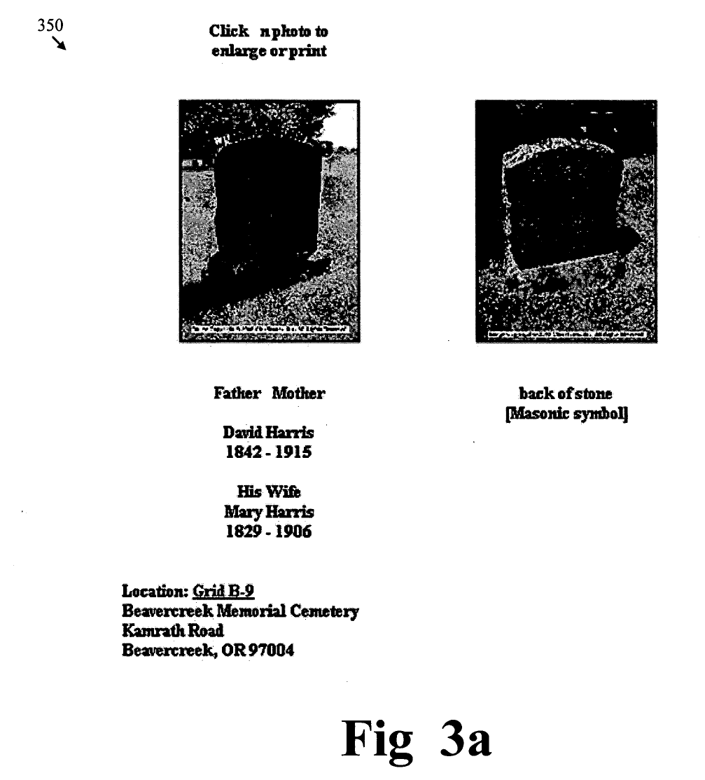

In one embodiment, the center images 202, the adjacent images 208, and the biographical information 126 listed below each image is a link. A user may click on the center image 202, one of the adjacent images 208, and biographical information 126 and a pop-up menu may appear containing several options with a user. A user may click on a link with a computer mouse, keyboard, and the like. In one embodiment, a user may have an option to zoom in and view the center image 202 and adjacent images 208. In a second embodiment, a user has an option to print the center image 202 and one of the adjacent images 208. A user may further view an enlarged image 300 of the center image 202 and adjacent images 208 as shown in FIG. 3. The enlarged image 300 may be displayed to a user by means of a GUI module 116. In one embodiment, the enlarged image 300 may be displayed to a user by means of the password protected website 120.

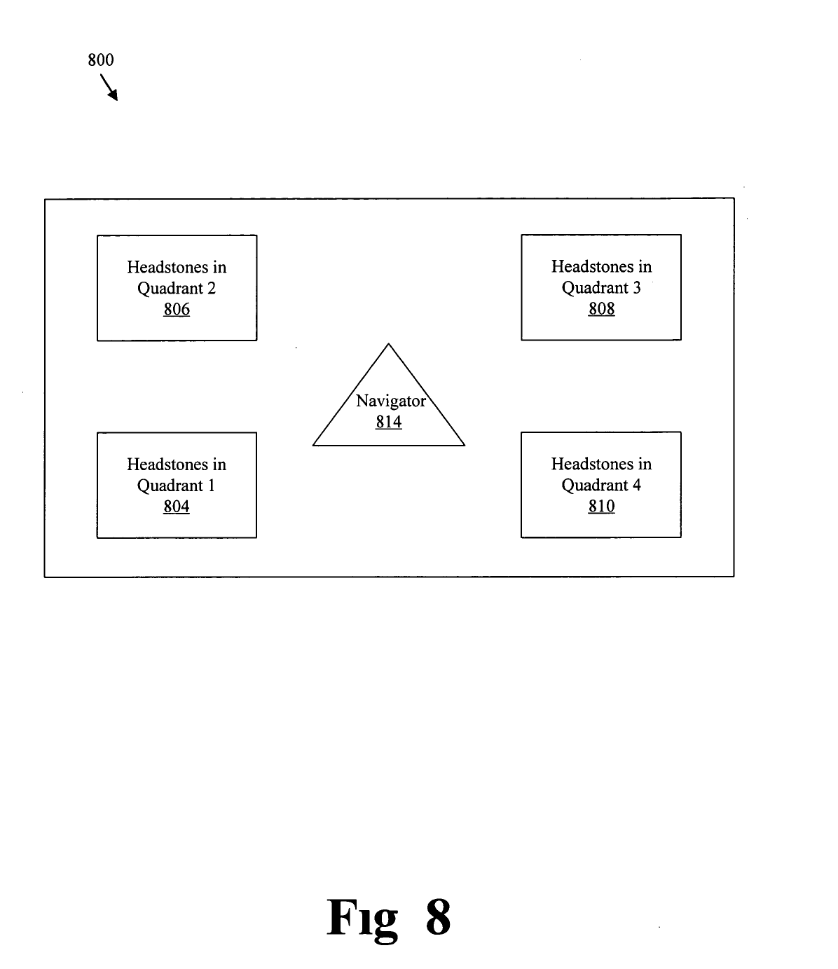

The display 200 further includes a cemetery link 210. A user may click on the cemetery link 210 and, in one embodiment, the user is displayed a virtual map 800 of a cemetery as shown in FIG. 8. The virtual map 800 may be displayed to a user by means of the GUI module 116 as described in FIG. 1.

FIG. 2a illustrates a representative example of a graphical display 250 of a sector of a graveyard. The sector may be accessed using the screen of FIG. 1b. Clicking on a representation of a gravestone will allow a user to view information pertaining to the gravestone, as shown in one example in FIG. 3a.

Reference is now made to FIG. 3. The enlarged image 300 of the center image 202 or one of the adjacent images 208 is displayed to a user. In one embodiment, the enlarged image 300 is displayed to a user by means of a password protected website 120 within the GUI module 116. The enlarged image 300 may include a link to additional information. For example, if a user clicks on the enlarged image 300 with a computer mouse, keyboard, and the like, a pop-up menu may be displayed to the user with various options. The options displayed to a user may include options to view the enlarged image 300 at different angles. This facilitates a user to view the enlarged image 300 from the side, front, and back. Often times biographical information 126 may be contained on the side, front, and back of the enlarged image 300. A user may also have an option to print the enlarged image 300. FIG. 3a illustrates a graphical display 350 illustrating representative information that may be shown when a user selects to view more information about a headstone. For example, clicking on the headstone for David and Mary Harris in FIG. 2a may result in the display of FIG. 3a in one embodiment.

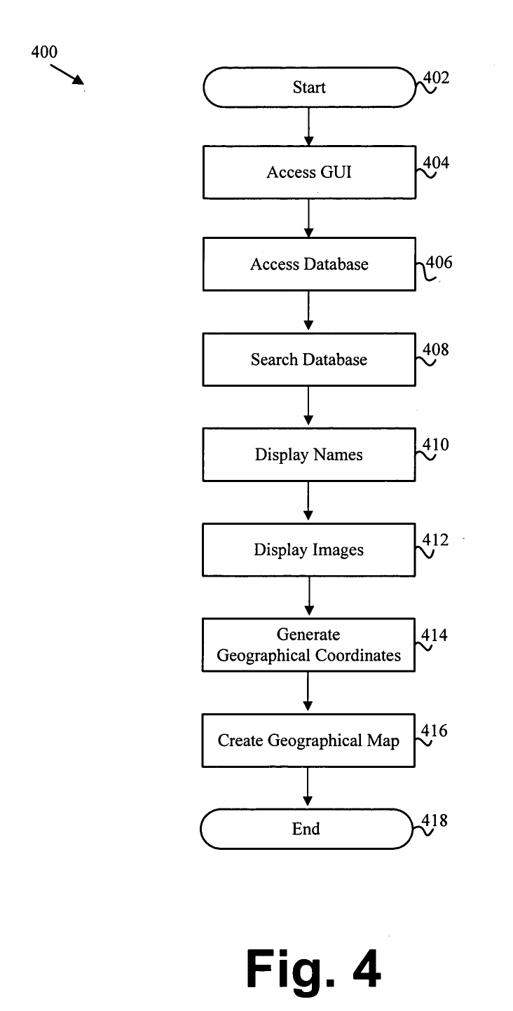

FIG. 4 illustrates an accessing cemetery records method 400. The method 400 begins 402 by a user accessing 404 the GUI module 116. The GUI module 116 may be accessed through a password protected website 120. After a user accesses 404 the GUI module 116, the user may access data 406 by means of the database of records 102. The user may then search 408 the database of records 102. The user may search 408 by entering names of deceased individuals, cemeteries, and the like in a computer field located within the password protected website 120.

The accessing method 400 proceeds to display names 410 to a user. The display 410 may include the name list 124, biographical information 126, and headstone information 128. The display 410 may also include names of cemeteries accessed through the cemetery module 108 described in FIG. 1. A user may select a name from the name list 124 and the method 400 proceeds to display images 412. The images may include images of graves, headstones, tombstones, and the like by means of the grave image module 106. The images may include the center image 202 and adjacent images 208 arranged to reflect the same relative locations of as the graves are located at a cemetery.

After images have been displayed to a user, the method 400 continues to generate 414 geographical coordinates of the displayed image. The geographical coordinates are generated 414 by means of the position module 114 as described in FIG. 1. The method 400 proceeds to create 416 a geographical map of a cemetery and the method 400 ends 418. In one embodiment, the geographical map is the virtual map 800 describe in FIG. 8.

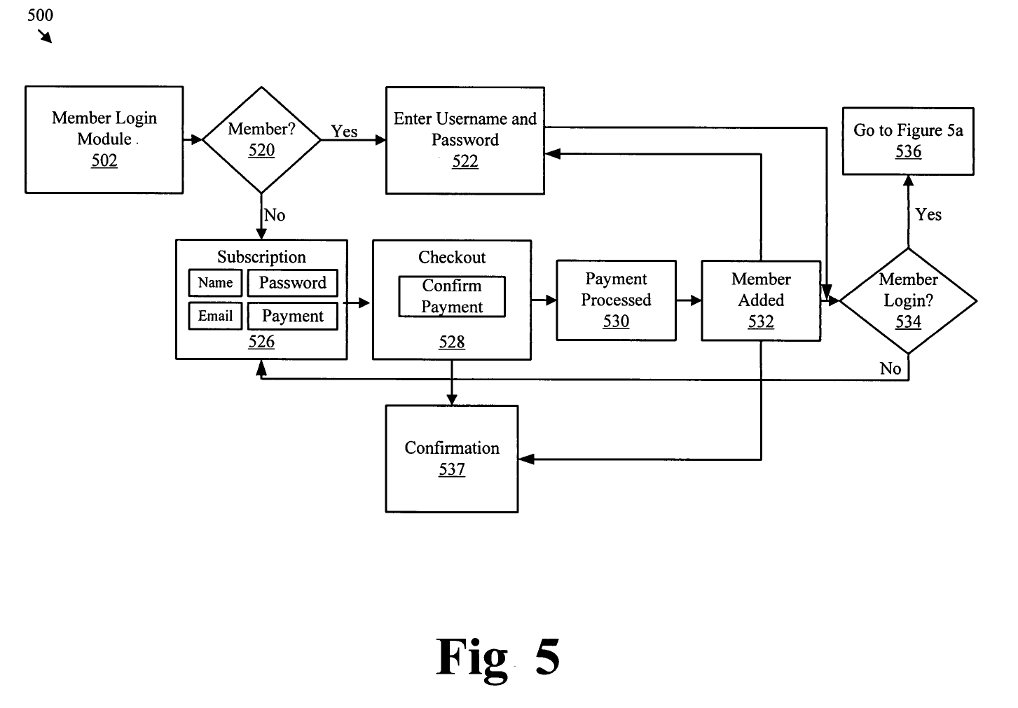

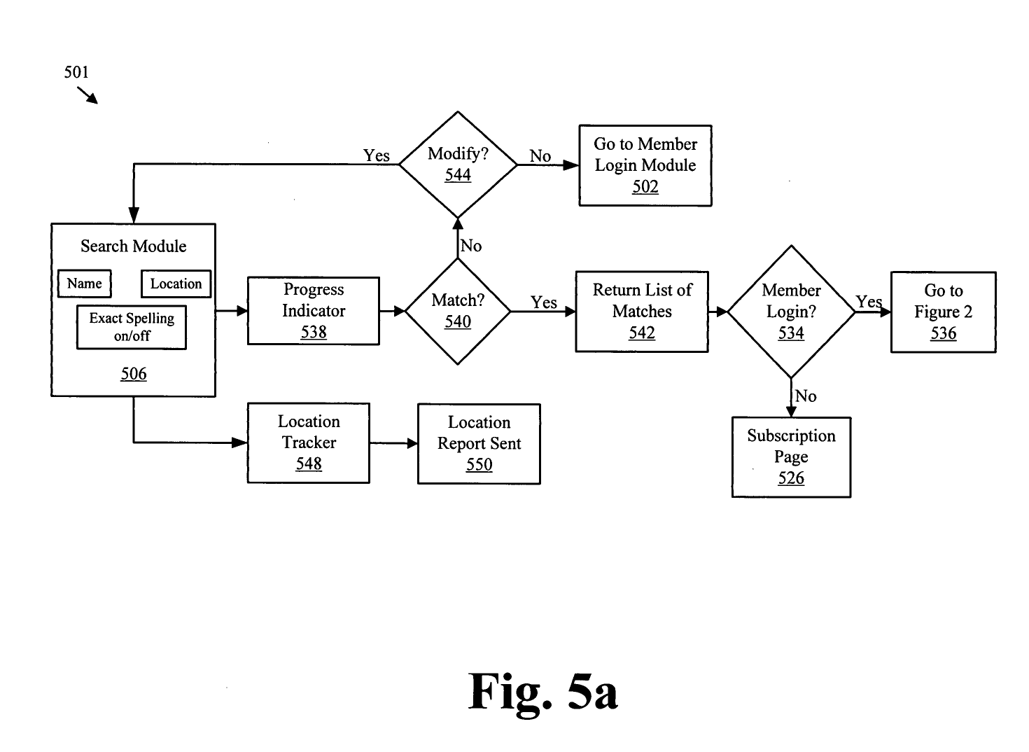

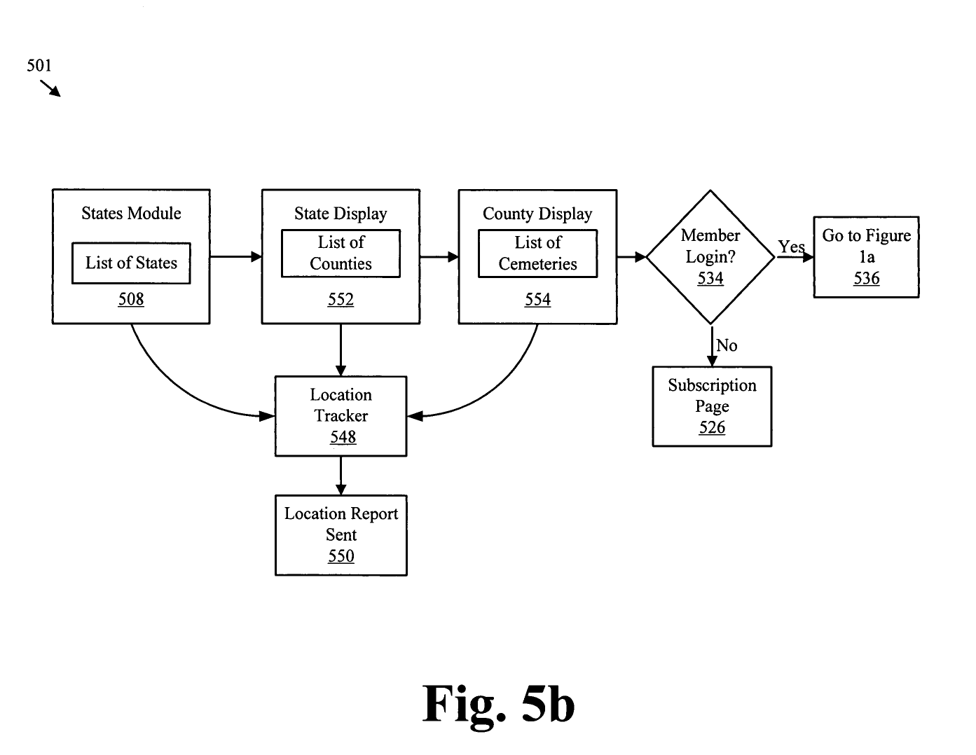

FIG. 5 illustrates a login method 500 of the present invention. The login method 500 maybe executed in accordance with the password protected website 120 within the GUI module 116. A user accesses the password protected website 120 on the Internet. A member login module 502 facilitates to determine is a user is a registered member of the password protected website by means of a member step 520. If a user is a registered member, the user enters 522 a username and password. A member login step 534 determines if the username and password were entered correctly and if the user has successfully logged onto the password protected website 120. If the user successfully logs onto the website 120, the method 500 proceeds to a step 536, which accesses and displays a search module 506 described in FIG. 5a.

If a user is determined not to be a registered member of the password protected website at the member step 520, a subscription display 526 is displayed to the user. In one embodiment, the subscription display 526 is a website. The subscription display 526 may comprise computer fields that facilitate a user to enter a name, password, email address, and a payment preference such as a credit card number, bank account number for automatic withdrawal of payment, and the like. In one embodiment, the name entered functions as a username for the user.

The login method 500 proceeds to display a checkout display 528 to a user. In one embodiment, the checkout display 528 is a website that provides the user an opportunity to confirm the payment preference entered in the computer field within the subscription display 526. Payment is then processed at a payment processed step 530 and the information pertaining to the user is entered into the database of the password protected website 120 at a member added step 532. In one embodiment, the member login method 500 proceeds to send an email to the user at a confirmation step 537. The confirmation step 537 facilitates a user to review the name, password, and the like the user previously entered within the subscription display 526. The method 500 proceeds to determine if the user is a registered member at the member login step 534. If the user successfully accesses the password protected website 120 at the login step 534, the method 500 proceeds to the step 536 to display to the user the search module 506 described in FIG. 5a.

FIG. 5a illustrates a search method 501 that includes the search module 506 that facilitates a user to search the database of records 102 as described in FIG. 1. In one embodiment, the search module 506 is located within the password protected website 120. In a second embodiment, the search module 506 is located within the free access website 118.

The search module 506 allows a user to enter a name of an individual that is deceased. In one embodiment, the name is entered in a computer field located within the search module 506. The user may also enter a geographical location such as a name of a cemetery. Entering a geographical location narrows the search of the deceased individual to the database of records 102 located within the entered geographical location. The search module 506 further facilitates a user to search the database 102 for the exact spelling of the deceased individual's name and exact spelling of the geographical location entered.

The login method 500 proceeds to a progress indicator step 538. The indicator step 538 may inform the user of the progress of the search executed by the search module 506. The method 501 continues to determine if the name of a deceased individual and the name of the geographical location match a name and geographical location within the database 102 at a match step 540. If the search does not provide a successful match at the match step 540, the user is provided with the option to modify the search at a modify search step 544. The modify search step 544 facilitates a user to search for a different name of a deceased individual and a different geographical location. If the user elects not to perform a modified search, the member login module 502 is accessed as described in FIG. 5.

If a match is successful at the match step 540, the method 501 proceeds to display a list of matches to the user at a return step 542. In one embodiment, the list of matches may comprise the list of names 124 with corresponding biographical information 126 and headstone information 128 as described in FIG. 1a. The method 501 continues to determine if the user is a registered member of the password protected website 120 at the login step 534. If the user successfully logs into the password protected website 120 at the login step 534, the method 500 proceeds to access the display 200 as described in FIG. 2. If the login step 534 determines the user is not a registered member, the method 501 proceeds to access the subscription display 526 as described in FIG. 5.

Once the search module 506 executes a search, a location tracker 548 records the geographical locations entered by the user within the computer fields located within the search module 506. The location tracker 548 facilitates to send a location report 550 to a Webmaster of the free access website 118 and the password protected website 120. In one embodiment, the location report 550 contains a history of geographical locations that have been entered within the search module 506.

FIG. 5b illustrates a second embodiment of the search method 501 that includes a states module 508 that facilitates a user to search for names of cemeteries located in a specific state of the United States of America. A user selects a specific state from a list of states within the states module 508. The method 501 proceeds to display a state display 552 to the user. In one embodiment, the state display 552 is a website with a list of counties located within the specific state. A user may select a specific county located within a state and the method 501 continues to display a county display 554 to the user. In one embodiment, the county display 554 is a website that contains a list of cemeteries located within the specified county. The location tracker 548 records each state, county, and cemetery selected by the user and sends the location report 550 to a Webmaster.

Once the user has selected the specific state, county, and cemetery, the login step 534 determines if the user is a registered member of the password protected website 120. If the user is determined to not be a registered member, the method 501 proceeds to access the subscription display 526 as described in FIG. 5. If the login step 534 determines that the user is a registered member, the method 501 proceeds to access the database 102 of the specified cemetery and may display to the user the list of names 124 pertaining to the database 102 as described in FIG. 1a.

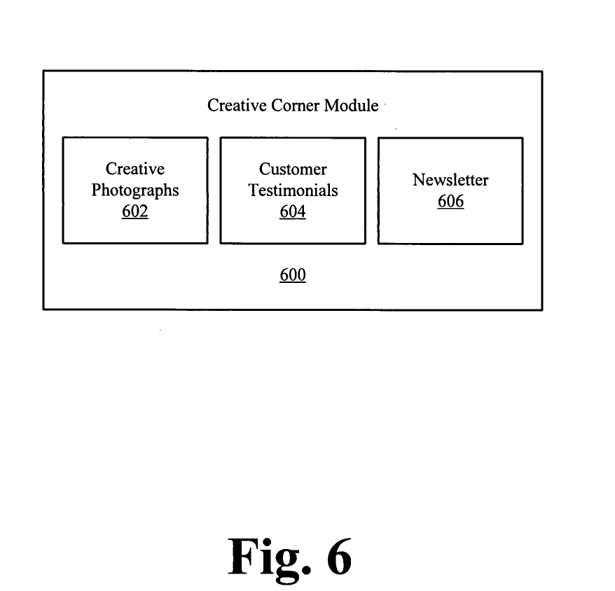

Referring now to FIG. 6, a creative comer module 600 is illustrated. In one embodiment, the creative comer module 600 is located within the free access website 118 and the password protected website 120. The creative comer module 600 may comprise a creative photographs link 602. The creative link 602 facilitates a user to access photographs of headstones, cemeteries, and scenery images surrounding the headstones and cemeteries. The module 600 may further comprise a customer testimonial link 604. The testimonial link 604 allows a user to access customer testimonials that may include comments from registered members of the password protected website 120. The creative module 600 may further include a newsletter link 606 that facilitates a user to access a newsletter that may comprise tips and suggestions on searching databases of cemetery records 102.

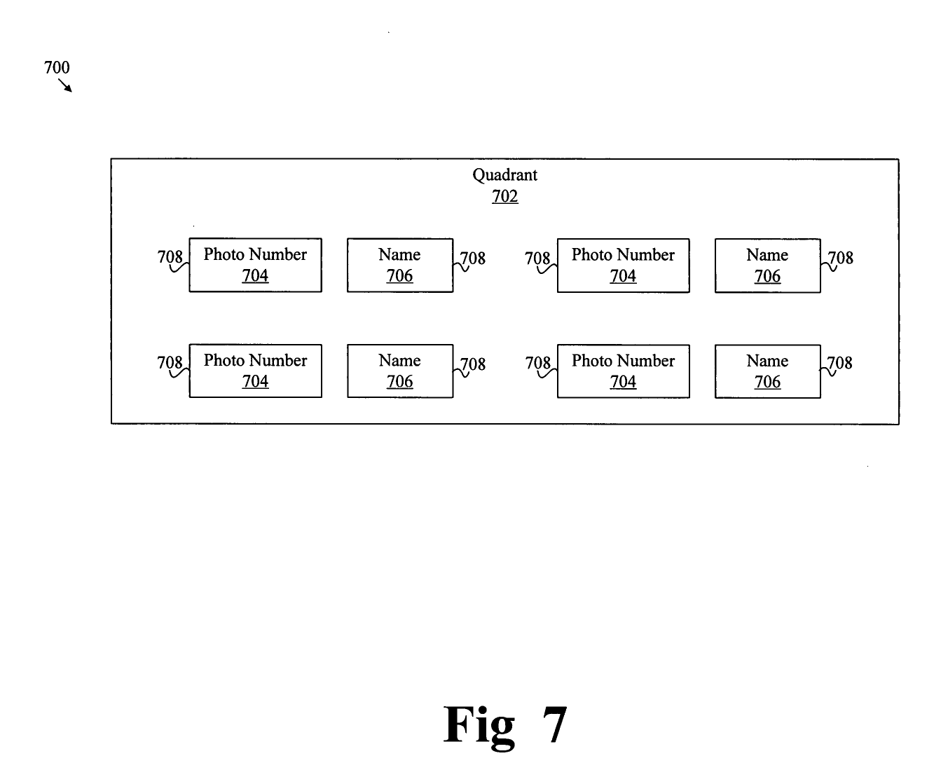

FIG. 7 illustrates a cemetery orientation worksheet 700. In one embodiment, the worksheet 700 facilitates data entry clerks of the password protected website 120 to maintain the database 102 current. The worksheet 700 may further facilitate photographers to submit photographs of headstones and cemeteries to the data entry clerks of the password protected website 120. The worksheet 700 may include digital photos and digital video of headstones located within a cemetery. The worksheet 700 allows the photos of the headstones to be arranged in the same relative locations of as they appear in the cemetery.

The worksheet 700 may be arranged in multiple quadrants 702. In one embodiment, each quadrant 702 includes several computer fields 708. Each computer field 708 may include a photo number field 704. The photo number may correspond to the number found on a digital camera when the digital photo of a headstone was taken. The photo number may then be entered in the photo number field 704. The photo number may facilitate to provide a unique identifying number obtained through Global Positioning System (GPS) technology. The unique identifying number may provide the geographical coordinates of a particular headstone within a cemetery.

Names of individuals 706 that appear on a headstone may be entered into different computer fields 708 within the same quadrant 702. The names 706 entered into each computer field 702 facilitate to create a virtual map 800 of a cemetery.

FIG. 8 illustrates one embodiment of the virtual map 800 of a cemetery. The map 800 may include photos of headstones located in various quadrants of the cemetery such as quadrant one 804, quadrant two 806, quadrant three 808, and quadrant four 810. The photos of the headstones in the various quadrants may comprise computer links. The quadrants listed in the map may correspond to the quadrants 702 described in FIG. 7.

The virtual map 800 may further include a navigator 814. In one embodiment, the navigator 814 may be a computer mouse, cursor, and the like. The user may move the navigator 814 over the link of the desired quadrant and the user may then access the photos of the headstones located in the specified quadrant.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A device for accessing cemetery records, the device comprising:
a database containing records, the records including biographical information of deceased individuals; and
a graphical user interface module configured to display to a user a representation of the records arranged to reflect the relative locations of the graves to which the records correspond.

2. The device of claim 1, further comprising a display module configured to provide an alphabetical list of names of deceased individuals contained within the database of records to a user.

3. The device of claim 1, further comprising a grave image module configured to provide digital representations of the graves to a user.

4. The device of claim 1, further comprising a global positioning system module configured to provide the geographical coordinates of individual graves to a user.

5. The device of claim 1, wherein the database of records further comprises the names of cemeteries.

6. The device of claim 3, further comprising a password protected website configured to provide the digital representations contained within the grave image module to a user.

7. The device of claim 1, further comprising a name module configured to access the records using the name of a deceased individual.

8. The device of claim 1, further comprising a cemetery module configured to access the records using the name of a cemetery.

9. The device of claim 1, further comprising a location module configured to access the records using a geographical location of a cemetery.

10. The device of claim 1, further comprising a sound module configured to perform a phonetic search on a name of an individual.

11. A method for accessing cemetery records, the method comprising:
providing a database of records, the records including biographical information of deceased individuals; and
displaying to a user a representation of the records arranged to reflect the relative location of the graves to which the records correspond.

12. The method of claim 11, further comprising displaying an alphabetical list of names of deceased individuals to a user.

13. The method of claim 11, further comprising providing digital images of graves to a user.

14. The method of claim 11, further comprising providing the geographical coordinates of a grave to a user.

15. The method of claim 11, wherein displaying a representation of the records further comprising accessing a GUI module through a website.

16. The method of claim 15, wherein accessing a GUI module further comprises providing a password protected website.

17. The method of claim 11, further comprising accessing a GUI module through a computer readable device.

18. The method of claim 11, further comprising performing a phonetic search on a name of an individual.

19. The method of claim 11, further comprising creating a geographical map of a cemetery.

20. A method for accessing cemetery records, the method comprising:
providing a database of records, the records including biographical information of deceased individuals;
displaying to a user a representation of the records arranged to reflect the relative locations of graves to which the records correspond;
providing an alphabetical list of names of deceased individuals contained in the records to a user;
providing digital representations of the graves to a user, wherein displaying the representation of the records is conducted using a graphical user interface accessible through a password protected website.
